(19) United States
(12) Patent Application Publication
(10) Pub. No.: US 2019/0161818 A1
(43) Pub. Date: May 30, 2019

(54) COLLET CHUCK FOR CLAMPING A DENTAL TOOL AND METHOD FOR MANUFACTURING SUCH A COLLET CHUCK

(71) Applicant: MINEBEA MITSUMI Inc., Nagano (JP)

(72) Inventors: Jürgen Bossler, Leutkirch (DE); Martin Engler, Leutkirch (DE)

(21) Appl. No.: 16/193,504

(22) Filed: Nov. 16, 2018

(30) Foreign Application Priority Data
Nov. 17, 2017 (DE) 102017220631.4

(51) Int. Cl. C21D 9/00; C21D 6/00; C21D 1/18; C21D 1/06; C23C 8/26; C23F 17/00; C22C 38/44; C22C 38/46; C22C 38/06; C22C 38/04; C22C 38/02; C22C 38/00; B23B 31/20; A61C 1/14

(52) U.S. Cl. CPC C21D 9/0068; B23B 2222/84; C21D 1/18; C21D 1/06; C23C 8/26; C23F 17/00; C22C 38/44; C22C 38/46; C22C 38/06; C22C 38/04; C22C 38/02; C22C 38/002; C22C 38/001; B23B 31/202; A61C 1/144; C21D 2211/001; C21D 6/002

(57) ABSTRACT

The invention relates to a collet chuck for clamping a dental tool, wherein the collet chuck has at least temporarily a mechanical stress applied to it and is made of steel.

The collet chuck according to the invention is characterized in that the steel, at least in a surface layer, has a nitrogen content of at least 0.1 wt %.

The present invention relates to a collet chuck for clamping a dental tool and a method for manufacturing such a collet chuck. Such collet chucks are subjected to regular disinfection and/or sterilization.

Generic collet chucks are used in the dental field and are therefore also called dental collet chucks. Such a collet chuck is used, for example, in a clamping device for clamping a dental tool in a dental handpiece, wherein the collet chuck is able to be elastically deformed by means of an actuator to be able to removably accommodate and hold the dental tool in the dental handpiece. Such collet chucks fix the dental tool and transmit driving power to the dental tool, for example to a cylindrical shank of the dental tool. Herein, various demands are placed on the collet chuck. For example, the collet chuck must have high strength, since the quasi-static mechanical load that is placed on the collet chuck during use must not lead to macroscopic plastic deformation or breakage. Due to the rotary drive of the collet chuck and the repeated elastic deformation, the collet chuck must have high fatigue strength, since dynamic mechanical loading, for example fatigue loading, must not lead to macroscopic plastic deformation or breakage. The material of the collet chuck must therefore have good ductility, or have a good ability to absorb deformation work. Because the dental tool is usually slid into the collet chuck, to be embraced by the latter, and is withdrawn from the collet chuck in the axial direction for tool change, sliding operations are performed on the surface of the collet chuck, in particular involving high pressure forces, which promote wear. Therefore, requirements with respect to high wear resistance are placed on the defined surfaces on which the sliding operations involving particularly high pressure forces are performed.

The increasing demands on hygiene in the medical and, in particular, the dental field, lead to increasingly aggressive media and methods for disinfection and sterilization. Therefore, the collet chucks must be made of a corrosion resistant material. Because of the above-mentioned high-strength requirements having to be fulfilled at the same time, ferritic steels are usually used, which are martensitically hardened. Typical examples are steels having a carbon content of ≥0.5 wt %. Finally, the collet chucks must have the ability to be manufactured in a low-cost manner.

An example of a clamping device with a corresponding collet chuck is disclosed in DE 10 2012 023 437 A1. In accordance with this disclosure, the collet chuck is of a corrosion resistant steel. The collet chuck shown is actuated by means of a pushbutton mechanism arranged to be axially displaceable and comprising a pressure piece. The actuation force should be low, so that releasement of the collet chuck is enabled. At the same time, a high holding force of the collet chuck should be ensured, which leads to the collet chuck being exposed to high mechanical loads, in particular has a high mechanical stress applied to it.

DE 10 2009 005 578 A1 discloses a medical instrument of a ferritic chromium steel formed of a ferritic core with an essentially martensitic surface layer. The surface hardness of the surface layer is greater by 32-300% than the smallest hardness of the ferritic core. The ferritic core is provided because austenitic steels comprising thin hardened layers applied to the surface of the steel, such as of titanium carbide TiC, titanium nitride TIN or DLC are regarded as disadvantageous because of the risk of the hardened layer flaking off. Nitrided and plasma-nitrided martensitic steels are regarded as disadvantageous due to their property that a phase change does not take place in the surface.

DE 40 33 706 A1 generally discloses case hardening with nitrogen to improve the corrosion resistance of martensitic stainless steels. For this purpose, the carbon is replaced by nitrogen at the cost of only losing little hardness, which leads to substantial improvement of the corrosion resistance, in particular when exposed to chloride-containing aqueous media. Herein, nitrogen contents exceeding the solubility of a steel melt at normal pressure are introduced into the steel by means of pressure or powder metallurgy. In practice it has been shown, however, that there is a risk that the nitrogen will diffuse out of the martensite over time so that the corrosion resistance is correspondingly reduced.

EP 2 159 295 B1 discloses a martensitic stainless steel and an antifriction bearing comprising such a steel, wherein the steel has high strength and toughness.

DE 44 46 985 A1 discloses a holder for a dental cutting tool with a collet chuck comprising a tough core with a hard surface. The hard surface can be achieved by nitriding, plasma nitride treatment or carburizing. Alternatively, coating methods with titanium nitride, and titanium chromium alloy and other methods can also be used.

Even though the well-known collet chucks of the prior art clamping devices, through the use of a hardened stainless steel, theoretically have the required strength for receiving the mechanical loads involved in operation, in practice, sometimes collet chucks have been found to have cracks negatively affecting the functioning of the collet chuck or leading to failure of the collet chuck.

It is therefore the object of the present invention to provide a collet chuck, wherein the collet chuck has at least temporarily a mechanical stress applied to it and is made of steel, for clamping a dental tool, wherein the undesirable formation of cracks is eliminated also in practice. Furthermore, a method of manufacturing a corresponding collet chuck is also provided.

The object according to the invention is solved by a collet chuck and a method according to the independent claims. The dependent claims define particularly advantageous embodiments of the invention.

The solution according to the invention is initially based on the idea that the cracks found in practice are caused by stress corrosion cracking, which usually happened when the collet chuck was disinfected or sterilized in a state where mechanical stresses were applied to it, for example due to a dental tool staying inserted in the clamping device. The sometimes chlorine-containing substances used for disinfection or sterilization are aggressive to the collet chuck surface in such a way that it leads to stress corrosion cracking, in particular when the surfaces are exposed to the substance in the stressed state.

According to the present invention, therefore, for a collet chuck for clamping a dental tool, wherein the collet chuck is regularly exposed to disinfection and/or sterilization operations, for example while using chlorine-containing substances, and wherein the collet chuck is made of steel and has at least temporarily mechanical stresses applied to it, a nitrogen content in the steel of at least 0.1 wt % is provided. The nitrogen content can be provided over the entire collet chuck or at least in a surface layer, to the outer surface of which such disinfection substances and/or sterilization substances are at least temporarily applied.

According to a preferred embodiment, the entire collet chuck, rather than just the surface layer, has a substantially homogeneous nitrogen content of at least 0.1 wt %. This means that the collet chuck has a nitrogen content of at least a 0.1 wt % from its steel core to its surface. This can be achieved, for example, by producing the steel by a melting method in which the melt of the steel and/or the steel during a subsequent heat treatment has a nitrogen atmosphere applied to it under pressure in such a manner that the nitrogen contained in the melt or in the steel remains in the melt or steel, respectively, and/or nitrogen from the nitrogen atmosphere additionally diffuses into the melt or steel, respectively, and the steel after solidification and/or after heat treatment has at least substantially a homogeneous nitrogen content so that the collet chuck manufactured from such steel has this nitrogen content from the core to its surface. Compared to the methods in which nitrogen is subsequently introduced into the surface layer, for example by means of nitriding, the present method has the advantage that undesirable reduction of the nitrogen content in the surface layer by means of diffusion is largely avoided, because there is sufficient nitrogen in the component overall that even when nitrogen diffuses out of the surface layer sufficient nitrogen remains in the surface layer or nitrogen diffuses into the surface layer from the inside.

Preferably, the steel, of which the collet chuck is made, at least in the surface layer, or overall, has a nitrogen content of at least 0.3 wt %.

According to one embodiment of the invention, the steel, at least in the surface layer, or overall, has a chromium (Cr) content of 10 to 20 wt %, preferably 13 to 17 wt %.

It is advantageous for the steel, at least in the surface layer, or overall, to have a content of molybdenum (Mo) of 1.0 wt % to 3.0 wt %, preferably 1.4 wt % to 3.0 wt %.

A vanadium (V) content is advantageously 0.1 wt % to 1 wt %, preferably 0.1 wt % to 0.5 wt %.

The steel, in particular, at least in the surface layer or overall, is at least substantially free of sulfur, i.e. it has a sulfur (S) content of 0.005 wt % max.

The carbon content of the steel, at least in the surface layer, or overall, is preferably between 0.2 wt % and 0.6 wt %, in particular between 0.3 wt % and 0.5 wt %, and particularly preferably 0.4 wt %. Alloys having proven particularly advantageous for at least the steel core or the steel core and the surface layer, are the following:

1. 0.4 wt % C, 15.5 wt % Cr, 2 wt % Mo and 0.2 wt % N

2. 0.4 wt % C, 16 wt % Cr, 3 wt % Mo and 0.15 wt % N

3. 0.4 wt % C, 15.5 wt % Cr, 1.7 wt % Mo and 0.2 wt % N.

The above first or third alloys are produced, for example, in accordance with the German Standard DIN 1.4123, the second alloy is also referred to as GP3. Details of these alloys can be derived from the Patent specification EP 2 159 295 B1.

Further components of the above first or third alloys are, for example, vanadium V, preferably 0.2 wt % to 0.4 wt %, Nickel Ni (preferably 0.5 wt % max) and manganese Mn (preferably 0.6 wt % max).

In the above first or third alloys the carbon content can also be in the range between 0.37 wt % to 0.45 wt %, a silicon Si content can be at 0.6 wt % max, a manganese Mn content at 0.6 wt % max, a phosphorous P content at 0.02 wt % max, a sulfur S content at 0.005 wt % max, a chromium Cr content at 15 wt % to 16 wt %, a molybdenum Mo content at 1.5 wt % to 1.9 wt %, a nickel Ni content at 0.5 wt % max, a vanadium V content at 0.2 wt % to 0.4 wt %, a nitrogen N content at 0.15 wt % to 0.25 wt %, and the iron Fe content the rest. Furthermore, inevitable impurities are also possible.

In the above second alloy, the carbon C content can also be 0.35 wt % to 0.45 wt %, a silicon Si content can be 0.2 wt % max, a manganese Mn content 0.3 wt % max, a phosphorus content 0.02 wt % max, a sulfur S content 0.02 wt % max, a chromium Cr content 15 wt % to 17 wt %, a molybdenum Mo content 1.5 wt % to 2.5 wt %, a boron B content 0.001 wt % to 0.003 wt %, a nitrogen N content 0.15 wt % to 0.25 wt %, a tungsten W content 0.1 wt % to 0.2 wt % (optionally) and iron Fe the rest. Again, inevitable impurities cannot be entirely excluded.

Preferably, the collet chuck is hardened, in particular, martensitically hardened. However, the hardness can be substantially less than the hardness maximally achievable. For example, the collet chuck has a surface hardness of 600 to 700 HV 10.

According to an embodiment of the invention, the surface layer has the above-mentioned nitrogen content of at least 0.1 wt % to, in particular, 0.3 wt %, wherein a steel core surrounded by the surface layer has at least less nitrogen than the surface layer, in particular, less than 0.1 wt % and in particular less than 0.01 wt % nitrogen.

The surface layer can have, for example, a greater hardness than the steel core.

According to an embodiment of the invention comprising the above-mentioned surface layer, the steel core has an austenitic microstructure.

A clamping device according to the invention for clamping a dental tool in a dental handpiece comprises a correspondingly formed collet chuck, which is able to be elastically deformed by means of an actuator.

The collet chuck is able to be expanded by means of the actuator for the accommodation of the dental tool, for example, by means of a push button mechanism as disclosed in DE 10 2012 023 436 A1 in various exemplary embodiments.

The steel can be produced, for example, by means of the electroslag remelting (ESR) method or pressure electroslag remelting (PESR) method, or in the vacuum arc remelting (VAR) method, wherein the steel or the collet chuck subsequently undergo heat treatment for hardening. The electroslag remelting method is a metallurgical method for the production of steel with particularly high purity, having a microstructure which directionally solidifies. In the pressure electroslag remelting method the remelting process is performed under a controlled gas atmosphere, for example in a protective gas atmosphere, or in a reactive gas atmosphere, such as with nitrogen, which dissolves in the steel during remelting and/or prevents or at least reduces the nitrogen diffusion out of the melt. Such a nitrogen atmosphere can achieve, in particular, the above-mentioned nitrogen content in the entire collet chuck.

The vacuum arc remelting method (VAR) is a remelting method using an electric arc, wherein a sub-type of arc remelting, the vacuum arc double electrode remelting (VADER) method, can also be used.

A preferred heat treatment after the production of the steel, wherein the step of remelting is also included in the production process, provides for careful heating of the steel to an austenitization temperature of 1000° C. to 1100° C., subsequent maintaining at the austenitization temperature of 1000° C. to 1100° C., followed by quenching (rapid cooling) to a temperature near room temperature, typically a temperature of less than 70° C., such as 0° C. to 70° C.

This is preferably followed by deep freezing of the steel at a temperature of −80° C. to −110° C., followed by reheating the steel back to room temperature.

This can be followed by tempering at 200° C. to 300° C., followed by cooling to near room temperature.

This is preferably followed by a second tempering operation, at 250° C. to 350° C., followed by cooling to near room temperature, i.e. to less than 70° C.

To manufacture the surface layer with the nitrogen content, an exemplary embodiment of the method according to the invention provides for the manufacture of the collet chuck, in which nitrogen is introduced into the surface layer by means of nitriding or plasma nitriding.

According to an embodiment of the clamping device according to the invention for clamping a dental tool in a dental handpiece, only the collet chuck comprises a corresponding nitrogen content. Other components of the clamping device can be produced, however, of low-nitrogen steel, in particular having a nitrogen content of less than 0.1 wt %, even if, for disinfecting and/or sterilizing, a suitable substance, in particular a chlorine-containing substance, is applied to it, but is subject to no or comparatively small mechanical stresses. Alternatively, components of the dental handpiece, such as the housing or parts of the housing, can also be made of a corresponding nitrogen-containing steel, for example, comprising one of the above-mentioned alloys.

The invention will be described in the following with reference to exemplary embodiments and the figures, in which:

FIG. 1 shows an exemplary embodiment of a clamping device comprising a collet chuck according to the present invention;

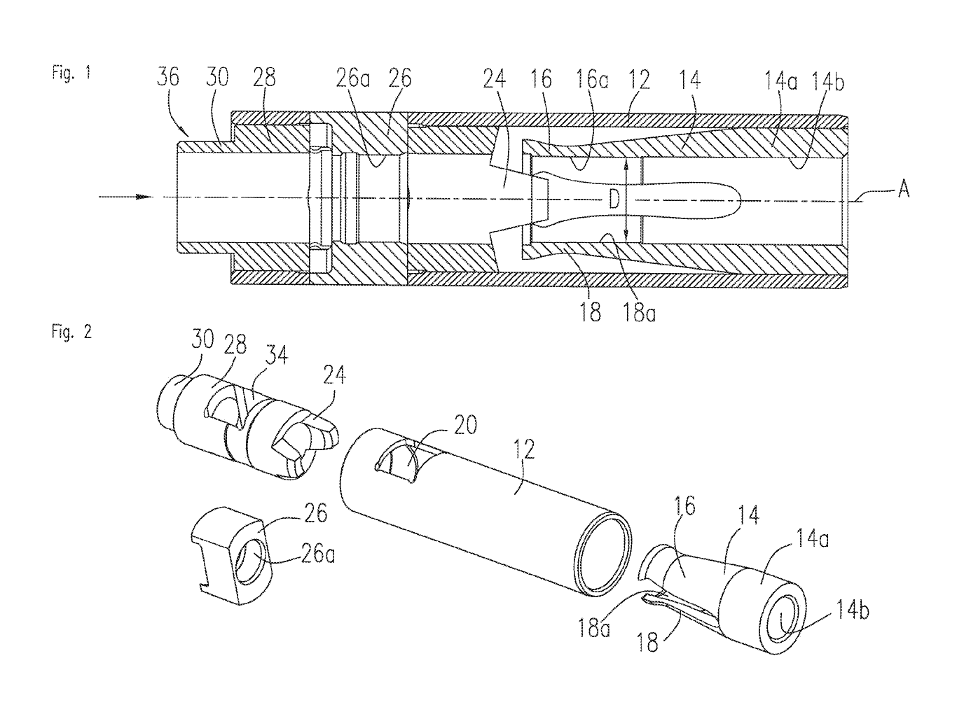

FIG. 2 is an exploded view of the clamping device of FIG. 1;

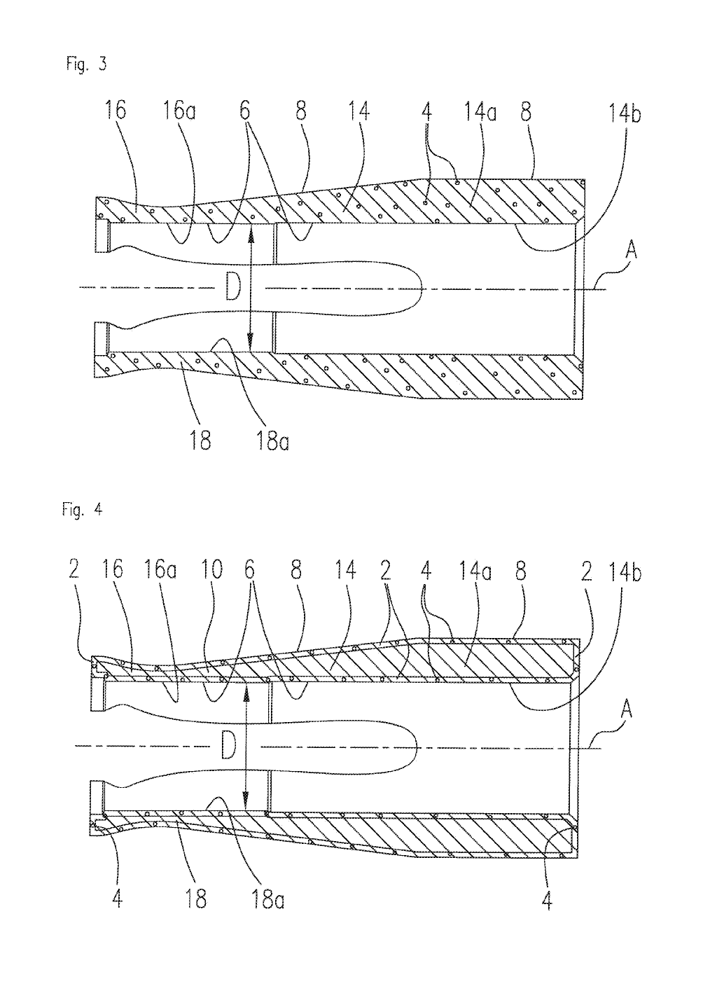

FIG. 3 shows a collet chuck such as it can be used in a clamping device of FIGS. 1 and 2, wherein the entire collet chuck comprises the inventive nitrogen content; and

FIG. 4 shows an exemplary embodiment similar to the one of FIG. 3, however, the collet chuck having a surface layer of the collet chuck comprising the inventive nitrogen content.

FIGS. 1 and 2 show an exemplary embodiment of a clamping device comprising a collet chuck 14, positioned within a housing 12. The collet chuck 14 comprises a sleeve-like, in particular hollow cylindrical section 14a which is fixed within the housing 12 so that the collet chuck 14 is held at least in the axial direction of axis A of the tool shank to be clamped in a fixed manner in the housing 12.

In the direction of a pushbutton 30 positioned on an axial end of the housing 12 opposite the section 14a, at least two clamping levers 16, 18 are arranged in succession to section 14a, which are elastically deformable and displaceable by means of an expanding element 24 in the radial direction against an elastic return force of the material of which the collet chuck 14 is formed.

The clamping levers 16, 18 have clamping surfaces 16a, 18a on their surfaces facing radially inwardly, preferably extending in an equidistant manner to axis A and which exert a clamping force on the tool shank in the clamped state of the tool shank of the dental tool, wherein in this state the clamping levers 16, 18 are elastically and radially outwardly deformed by a predetermined amount, so that the collet chuck 14 has a mechanical bending stress applied to it.

The clamping diameter of the collet chuck 14 is designated as D in FIG. 1.

To be able to insert the tool shank in and to withdraw it from the collet chuck 14, an expanding element 24 is positioned adjacent to the collet chuck 14 to be displaced in the axial direction in the housing 12, which, when it is axially displaced, penetrates the collet chuck 14 while radially outwardly pressing the clamping levers 16, 18 and thus pressing the clamping surfaces 16a, 18a apart in the radial direction, so that the tool shank is released from being clamped in the collet chuck 14. The displacement of the expansion element 24 is achieved by means of a pressure piece 28 comprising the pushbutton 30 protruding from the housing 12. For example, the expansion elements 24 are integrally formed with the pressure piece 28.

In the illustrated exemplary embodiment, but not necessarily, a supporting ring 26 which extends within a through hole 34 of the pressure piece 28 is inserted in a through hole 20 of the housing 12. This supporting ring 26 has a radially inner guiding surface 26a for the tool shank, which cooperates with a guiding surface 14b on the sleeve-like section 14a of the collet chuck 14 to guide the tool shank in the direction of the axis A.

The pressure piece 28, together with the expansion elements 24, forms an actuator 36 for the collet chuck 14.

The collet chuck 14 thus undergoes repeated elastic deformation when the clamping levers 16, 18 are expanded. Moreover, in each inserted state of a dental tool, due to the fact that the tool shank, for its clamping, prevents complete springing back of the clamping levers 16, 18 radially to the inside, a clamping force remains in the collet chuck 14. If a disinfection substance and/or sterilization substance, which is, in particular, a chlorine-containing substance, is applied to the collet chuck 14 in this state, there is a risk of stress corrosion cracking. For this reason, according to the present invention, the collet chuck 14, at least in the area of its surface, i.e. within a surface layer, is of a steel material having a nitrogen content of at least 0.1 wt %. This will be explained in an exemplary manner with reference to FIGS. 3 and 4:

In the exemplary embodiment of FIG. 3, the entire collet chuck 14 is made of a steel having a nitrogen content of at least 0.1 wt %. This is only schematically shown as nitrogen particles 4.

The radially inner surface 6 of the collet chuck 14 thus also has a corresponding nitrogen content, as well as the radially outer surface 8.

In the embodiment of FIG. 4, however, the collet chuck 14 has a surface layer 2 on all surfaces which can come into contact with the disinfection substance and/or the sterilization substance. According to an embodiment, it may also be sufficient to provide only those surfaces with a corresponding surface layer 2 that have a tensile stress applied to them, thus the radially inner surface 6.

For this reason, in the exemplary embodiment according to FIG. 4, the nitrogen particles 4 are provided in the surface layer 2, rather than in the steel core 10. While not shown in the figure, a transition layer with a reduced number of nitrogen particles 4 may form between the surface layer 2 and the steel core 10.

### LIST OF REFERENCE NUMERALS

2 surface layer
4 nitrogen particle
6 radially inner surface
8 radially outer surface
10 steel core
12 housing
14 collet chuck
14a section
14b guiding surface
16 clamping lever
16a clamping surface
18 clamping lever
18a clamping surface
20 through hole
24 expansion element
26 supporting ring
26a guiding surface
28 pressure piece
30 pushbutton
34 through hole
36 actuator
A axis of the tool shank to be clamped
D clamping diameter

1. A collet chuck for clamping a dental tool,
wherein the collet chuck has at least temporarily a mechanical stress applied to it and is made of steel,
characterized in that
the steel, at least in a surface layer, has a nitrogen content of at least 0.1 wt %.

2. The collet chuck according to claim 1, characterized in that the steel, at least in the surface layer, has a maximum content of nitrogen of at least 0.3 wt %.

3. The collet chuck according to claim 1, characterized in that the steel, at least in the surface layer, has a chromium content of 10 to 20 wt %.

4. The collet chuck according to claim 1, characterized in that the steel, at least in the surface layer, has one or more of the following components:
1.0 to 3.0 wt % molybdenum,
0.1 to 1 wt % vanadium.

5. The collet chuck according to claim 1, characterized in that the steel, at least in the surface layer, has one or more of the following components:
13 to 17 wt % chromium,
1.4 to 3.0 wt % molybdenum,
0.1 to 0.5 wt % vanadium.

6. The collet chuck according to claim 1, characterized in that the steel, at least in the surface layer, has a maximum content of sulfur of 0.01 wt %.

7. The collet chuck according to claim 1, characterized in that the collet chuck, at least on its surface, has a hardness of 500 to 700 HV 10.

8. The collet chuck according to claim 1, characterized in that the collet chuck overall, from a steel core up to and including the surface layer, has an at least substantially homogeneous nitrogen content of at least 0.1 wt %.

9. The collet chuck according to claim 1, characterized in that at least the surface layer has a carbon content of 0.37 to 0.45 wt %.

10. The collet chuck according to claim 9, characterized in that at least the surface layer has a chromium content of 15 to 16 wt %.

11. A clamping device for clamping a dental tool in a dental handpiece, comprising a collet chuck able to be elastically deformed by means of an actuator,
characterized in that
the collet chuck is formed according to claim 1.

12. The clamping device according to claim 11, characterized in that the collet chuck is able to be expanded by means of the actuator for the accommodation of a dental tool.

13. A method of manufacturing a collet chuck according to claim 1,
characterized in that
the steel is fabricated in the electroslag remelting method or pressure electroslag remelting method or vacuum arc remelting method, and the steel or the collet chuck is subsequently subjected to a heat treatment to increase the hardness.

14. The method according to claim 13, characterized in that the heat treatment comprises one or more steps, in particular in the following order:
heating to an austenitization temperature of 1000° C. to 1100° C.,
maintaining at the austenitization temperature of 1000° C. to 1100° C.,
quenching to a room temperature of <70° C.,
deep freezing at a temperature of −80° C. to −110° C.,
reheating to room temperature of between 0° C. and 70° C.,
tempering at 200° C. to 300° C.,
cooling to a room temperature of <70° C.,
tempering at 250° C. to 350° C.,
cooling to a room temperature of <70° C.

15. The method of manufacturing a collet chuck according to claim 13, characterized in that
a nitrogen-containing melt of the steel has a nitrogen atmosphere applied to it under pressure in such a manner that the nitrogen remains in the melt and/or the melt of the steel has a nitrogen atmosphere applied to it under pressure in such a manner that the nitrogen diffuses into the steel, so that the steel, after solidification, has an at least substantially homogeneous nitrogen content;
and/or in that
the nitrogen-containing steel, during a heat treatment after or during solidification, has a nitrogen atmosphere applied to it under pressure in such a manner that the nitrogen remains in the steel and/or the steel has a nitrogen atmosphere applied to it under pressure in such a manner that the nitrogen diffuses into the steel, so that the steel, after its heat treatment, has an at least substantially homogeneous nitrogen content.
